(19) United States
(12) Patent Application Publication
(10) Pub. No.: US 2012/0212938 A1
(43) Pub. Date: Aug. 23, 2012

(54) User Wearable Illumination Ring

(76) Inventors: David Nguyen, Miami, FL (US); Dat Nguyen, Los Angeles, CA (US)

(21) Appl. No.: 13/044,550

(22) Filed: Mar. 10, 2011

Related U.S. Application Data
(60) Provisional application No. 61/444,127, filed on Feb. 17, 2011.

(51) Int. Cl. F21V 21/08

(52) U.S. Cl. 362/104

(57) ABSTRACT

A wearable light ring used to illuminate a working area while allowing the user to hold a tool with the same hand. The battery powered ring including an LED and control mechanism. The LED positioned on the light ring as to direct most of the light towards the fingertip allowing the user to simultaneously work with a tool and illuminate the working area with one hand. The light ring also having a mode of operation that filters UV light to prevent curing of composite materials.

This application claims the benefit of the filing date of U.S. Provisional Patent Application Ser. No. 61/444,127 filed on Feb. 17, 2011, the disclosure of which is incorporated herein by reference.

### BACKGROUND OF THE INVENTION

1. Field

This invention relates to portable illumination devices, particularly to a light ring worn on a finger while allowing a user to handle tools and provide illumination to a working area. More specifically, it relates to illuminating the oral cavity during dental surgery.

2. State of the Art

Dental surgery as it is presently practiced involves the use of cumbersome, heavy, and ineffective lighting devices. Illumination of the oral cavity poses some challenges because the oral cavity is small and cavernous. Light from existing devices such as overhead lamps and those worn on a surgeon's head or eye glasses is often be blocked by a patient's teeth and the surgeon's tools, body or hands. Overhead lights and lights worn on the head may also irritate the patient's eyes. Furthermore, cables that power the headlight may hinder the surgeon's movement and become dirty during surgery. Alternatively, handheld mirrors have traditionally been used to aid with lighting by reflecting oncoming light from the conventional sources mentioned above. A major disadvantage of the use of handheld mirrors is that they occupy one of the surgeon's hands. The light, compact, and effective arrangement provided by this invention is thus desirable because it not only alleviates the stress and mess of conventional lighting sources, but also leaves the user's hands free to occupy other tasks.

U.S. Pat. No. 7,645,050 B2, USER-WEARABLE ILLUMINATION ASSEMBLY, by Wilt et al. describes a commonly used illumination device to be worn over a surgeon's glasses. The Wilt invention is cumbersome, heavy, and could cause strain on the user's neck if worn for extended periods of time. Additionally, repositioning of the light requires the user to move their head in potentially awkward positions or readjusting the lighting bracket with their hand; both are undesirable.

In the related art of portable illumination devices, U.S. Pat. No. 7,165,859 B1, LIGHTING DEVICE WITH RESILIENT FASTENER FOR ATTACHING TO HUMAN FINGER, by Munari describing a light device attached to the finger which directs light away from the knuckles or away from the palm. The device is cumbersome and ill-suited for surgery. The device does not direct light towards the operating area which is at the user's finger tips, but instead provides light in all directions which would provide unwanted illumination towards the operator's eyes.

A significant advancement in the art is described by U.S. Pat. No. 7,703,937 B2, HANDS FREE LIGHT EMITTING DIODE (LED) ILLUMINATION DEVICE, by Shirey describing a light ring which directs light downwards towards the user's palm to allow for reading of maps in dark situations. The Shirey invention is also ill-suited for surgery because during surgery light is needed at the front of the surgeon's fingers towards the working space not down at the palm as disclosed by the invention. The Shirey invention is further unable to be used while holding tools because the light source of the Shirey invention is positioned at the bottom of the ring facing the users palm and thus if the user were holding a tool while wearing the invention, the light would be blocked by the tool and the user's fingers. The intent of the Shirey invention is to provide light to military personnel for viewing maps in dark areas while allowing them to conceal the light with the opposing hand making the invention unusable for dental surgery or working with tools.

### SUMMARY OF THE INVENTION

The present invention provides an illumination device integrated into a wearable ring where the light is directed towards the user's finger tips allowing the user to handle tools freely and illuminate the working area at the same time. The instant invention takes advantage of the fact that while working with tools such as a pencil or scalpel, the user's index finger is pointed towards the working surface where illumination is most needed. Thus, if the user wears the present invention while using a tool, illumination will always be provided to the necessary working area.

The present invention is preferably illuminated using at least one light emitting diode (LED), but other equivalent illumination devices can be used in its place as is well known in the art such as LED tubes, traditional filament bulbs, and organic LEDs (OLED). It is preferable that illumination be provided at the upper portion of the ring (the sectional arc corresponding to the wearer's knuckles) directing light forward towards the finger tip. Depending on the illumination requirements of the user, multiple LEDS can be positioned throughout the upper portion of the ring. Additionally, illumination may also be provided on the side and/or bottom portions of the ring as well.

The ring and illumination is preferably, but not required, to be housed in a single construction. Stated another way, the ring, light source, battery, and control mechanism is to be housed within the circumference of the ring. The housing will have a clear front face in order to direct light towards the user's finger tips. The entire front face need not be clear, and in some embodiments, only a portion of the front face is provided with a clear window. The cylindrical inner circumferences and back face will not be clear in order to prevent undesired lighting towards the user's eyes. Sections of the cylindrical outer circumference may be clear to allow light to pass. Reflective material or coating may be further added to the inner cavity of the ring to reflect light towards the clear front face. These reflectors may also take the form of reflective sheets placed around the LEDs. In alternative embodiments, the ring may be constructing using an inner ring which houses the various components and an outer ring which will act as a shield and protective barrier for the working components of the ring.

The shape of the ring is preferably annular and uniform in shape, but in some embodiments the sides of the ring that would contact with other fingers may be reduced in thickness as not to hinder the user's movement.

Additionally, the ring may further be provided with a cover made of rubber or similar material to prevent the ring from being dirtied or damaged during use. The rubber cover will encase the front face, back face, the outer cylindrical surface and some of the inner cylindrical surface, but not its entirety to allow the cover to be taken on and off. A plurality of colors could be provided for the covers to suit the preference of the user and to help users distinguish one ring from another. Furthermore, the cover may only cover part of the front face if it is not made of a clear material as to allow proper functioning of the invention. If the cover were made of a clear material, the entire front face may be covered. The cover may be made from any suitable material as is known in the art; the use of rubber in the description is intended only for illustrative purposes. The cover may also be made of a material to filter certain types of light. Alternatively, a permanent clear coating made me applied to the ring to make it easy to clean, provide water proofing, and shock proofing. The coating may be made of rubber or a suitable synthetic alternative.

Specifically relating, but not limited to the field of surgery, the user is likely to be using the invention while wearing gloves which could vary in size and make wearing the present invention over the glove difficult. Thus in some embodiments, it is preferably to provide means for retaining the ring onto the user's finger where the size of the finger may be variable. This also allows for the user to switch the use of the ring among different fingers. One of such retention means include a plurality of protrusions made of an elastic material extending from the inner cylindrical surface of the ring towards the center. These elastic protrusions will deform when the ring is worn on the user's finger and will offer some resistance from forces that may cause the ring to fall off during use. Alternatively, an elastic curved flap (or multiple) may be used instead of a protrusion. In another embodiment, an inflation device may be used as the retention means being housed in the ring and extending into the inner cylindrical surface. The inflation device that may be actuated from a pump switch on the exterior of the ring. The user may pump the switch to inflate the retention means thus tightening the ring around the finger. To release the air pressure, the user presses and holds the pump switch. Alternatively, the retention means may involve a break at a section of the circumference of the ring (preferably at the side facing away from the user's thumb) and a strap may be used to connect the ends of the broken section in the circumference. The strap would be attached to one side of broken section and attached to the other side via a loop. The strap is preferably made of a material having hook and loop fasteners. This alternative requires the user to slide the ring on and then tighten the strap onto itself using the hook and loop fasteners. Finally, the retention means could be a male and female connection at a section of the ring that may be coupled to one another over the finger.

In some embodiments, the retention means may be the entire ring itself being made of an elastic material that may deform to attach to the user's finger. In such embodiments, the ring is preferably made from medical grade silicone for its ability to withstand autoclaving, elasticity, ease of manufacture, and resistance of water.

Another consideration in the field of dentistry is the danger of the device falling off into the patient's mouth during surgery. To address this danger, a notched hole or loop may be provided in the top section at the back face of the ring to allow a piece of dental floss to be attached to the ring and then tied to the dentist's finger.

A further consideration relating to the dental field is that the invention is preferably made autoclavable. Autoclaving involves subjecting the invention to high pressure saturated steam at 121° C. or more, typically for 15-20 minutes.

The battery is preferably, but not necessarily, a lithium battery. It may be either rechargeable or non-rechargeable. In embodiments where the battery is non-rechargeable, a battery cover may be constructed into the ring as to allow the user to replace the battery. In embodiments in which the battery is rechargeable, it is preferable that the ring may be recharged without the removal of the battery using inductive charging. The light assembly may also include indicator lights, green and red to indicate the charge level of the batteries. Green to indicate fully charged and red to indicate low battery power status.

For certain applications and industries, the invention may be adapted to provide means for filtering ultra-violate (UV) light. This is particularly desirable in the dental industry where UV light may cause undesired curing of composite materials. The present invention provides several options to prevent this. First, an additional LED may be provided near the primary LED. The additional LED will be coated with a UV filtering material. The ring would then have an additional mode of operation, one with standard white light and the alternative UV filtered mode. The ring may have more than one of such UV filtered LEDs depending on the lighting needs of the user and such LEDs can be placed next to the non-filtered LEDs in an alternating pattern as to allow equal light dispersion in both modes of operation. Additional control mechanism would be added to the control device to operate the UV filter mode of operation. Alternatively, a cover having a UV filter may be provided which slips over the ring as discussed above. Furthermore, the cover need not encase the entire ring, but could simply be a snap on or slide-able cover. Finally, an optional third LED color and mode of operation may be added to the device to allow for curing of composites. It is sometimes desirable to speed up the curing of composite materials and thus UV light (light having a wave length within the range of 400-500 nm is preferable, and 468-470 nm for optimal curing) is desired. Thus, the third mode of operation and third LED type would allow UV light to pass through and preferably at a greater intensity in order to accelerate curing of composite materials.

In some embodiments, a plurality of different colors and combinations of LEDs may be used depending on the desires of the user. In one embodiment, the invention is to be used for entertainment purposes and so a plurality of colors and modes of operations (strobe, alternating, and intensities) may be used.

The control means is preferably located at the bottom arc section of the ring, opposite to the top arc section where the LEDs are preferably located. Positioning the control means at this location allows the user to operate the ring with one hand using the thumb to interact with the control means. Furthermore, placing the control means at the bottom eliminates the need for left and right hand models since it can be worn on any finger and any hand while retaining the same level of operability. Alternatively, the control means may be located on the side which faces the thumb allowing the greatest ease of use, but would require specific left and right hand models. The location of the control means may be changed depending on the preference of the user. The control means is preferably a button for each type of LED function as discussed above. The simplest embodiment would have a single button controlling the LED in and on/off mode of operation and optionally additional depressions of the button may cycle through varying intensity levels. There may also be additional modes of operation that control the intensity of the light which may be controlled by either the same button, an additional button, sliding switch, rotatable wheel, or any equivalent as is well known in the art. In further embodiments where additional modes are desired, multiple control means may be implemented. Finally, to promote easy cleaning of the invention, it may be preferable to use control means that reduce the surface area that bacteria and contamination may occur such as in the crevices of buttons. Touch sensitive or buttons housed inside the ring having a deformable outer cover that is a singular construction with the outer surface may be preferable for uses which require cleaning of the invention.

### BRIEF DESCRIPTION OF THE DRAWINGS

The accompanying drawings, which are incorporated in and constitute a part of this specification, illustrate embodiments of the invention and, together with a general description of the invention given above, and the detailed description give below, serve to explain the principles of the invention.

FIG. 1 is a perspective view showing the front face of an exemplary user wearable ring.

FIG. 2 is a perspective view showing the back face of an exemplary user wearable ring.

FIG. 3 is front view of an exemplary user wearable ring.

FIG. 4 is a top and side view of the ring having a directed light protrusion.

FIG. 5 is a cross sectional view of an embodiment having an inner and outer ring.

FIG. 6 is a cross sectional view of an embodiment having an inner and outer ring that is curved.

FIG. 7 is a perspective view of the invention utilized in dental surgery.

### DETAILED DESCRIPTION

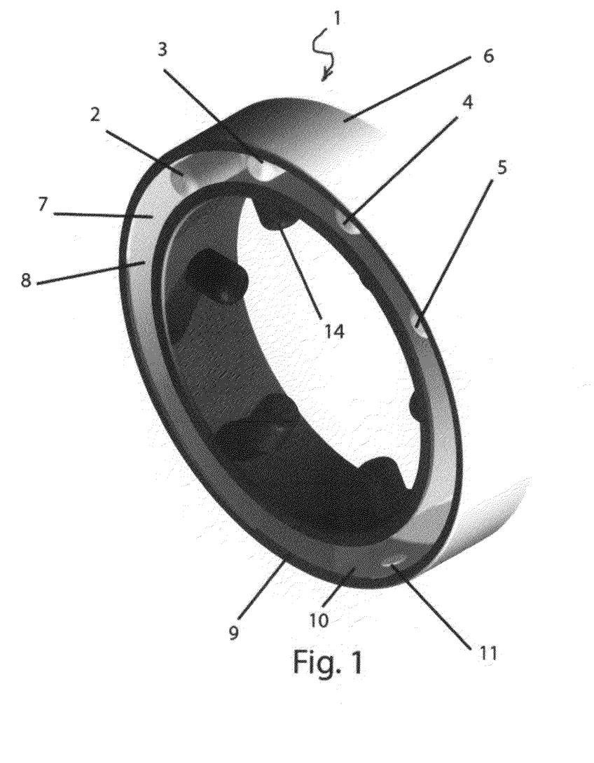

FIG. 1 depicts a preferred embodiment of the present invention. The ring assembly 1 is preferably of unitary construction. LEDs 2, 3, 4, and 5 are positioned across the top portion 6 of the ring to provide illumination towards the user's finger tips and working area. The LEDs 2 and 4 are provided with a UV filter while LEDs 3 and 5 are not. This allows for the ring 1 to operate in a normal mode of operation and a UV filter mode of operation which is desirable when working with composite materials that may be cured by UV light. The UV filter mode of operation thus allows for the user to work on composite materials without undesired curing. It is also anticipated that multiple arrangements of LEDs of different colors and filters could be arranged around the ring assembly 1 and with them multiple modes of operation including, individual on/off, group on/off, strobe effects, varying intensity, and synchronized patterns of illumination may be provided.

The front face 7 of the ring is clear to provide illumination towards the desired working area. The inner surface 8 is preferably lined with reflective material to maximize illumination. It is anticipated that reflectors may also be placed behind the individual LEDs 2, 3, 4, and 5.

The battery 9 and control mechanism 10 are preferably housed at the bottom of the ring assembly 1. This allows for one ring design to be used by multiple users without the need to make left and right handed models. In this embodiment, the user controls the ring by actuating several buttons 11, 12, and 13 (only 11 can be seen in this view) on the bottom of the outer circumference of the ring. It is also anticipated that the control mechanism 10 can be housed on the right side facing the user's thumb which would allow for greatest east of use, but would require left and right hand models and reduce operability when used on the wrong hand.

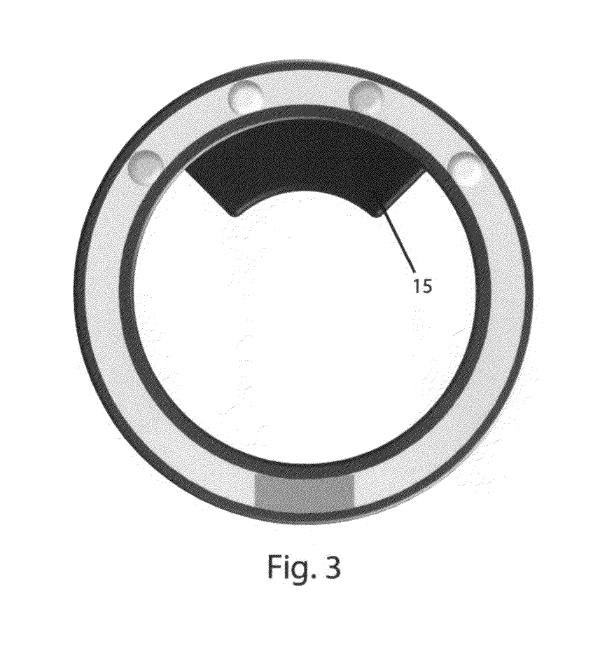

A plurality of elastic protrusions 14 extend from the inner circumference of the ring towards the center. The elastic protrusions 14 deform when the ring is placed on a finger and provide forces to keep the ring in place. They also allow for the ring to be used on multiple fingers where the size can be varied. They also allow the user to wear the ring over gloves. It is anticipated that an elastic curved flap 15 may be used to retain the ring and vary the size as depicted in FIG. 3. It is further anticipated that a plurality of alternative retention means may be used in place of the elastic protrusions 14 such as, an inflating pump, hook and loop fasters on a strap, and male and female couplers as described above.

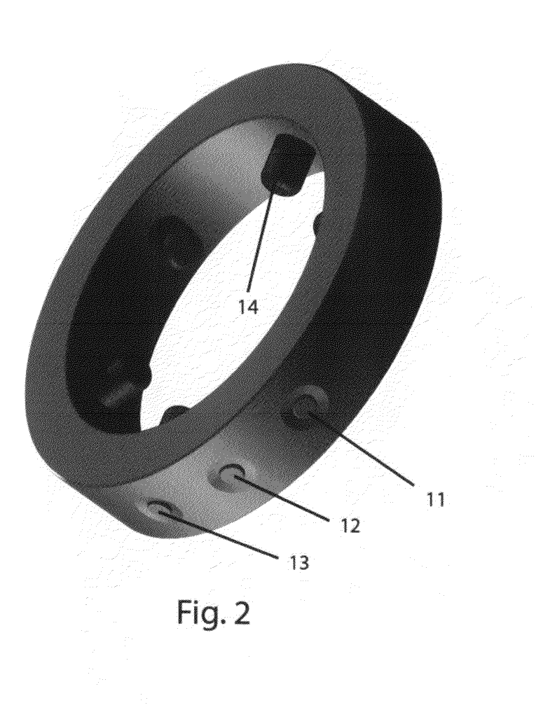

Referring to FIG. 2, the control mechanism 10 (not shown) houses several buttons 11, 12, and 13 for controlling different modes of operation. Button 11 controls the power to the ring, button 12 controls the intensity of the normal mode of operation, and button 13 controls the intensity of the UV filter mode of operation. It is anticipated that different control schemes may be used. Furthermore, it is also anticipated that sliding switches, rotatable dials, or levers may also be used as control means.

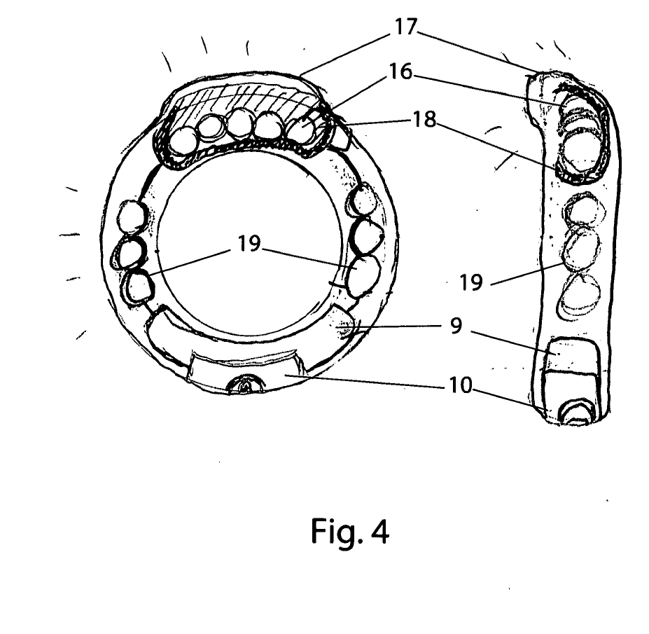

FIG. 4 depicts a front and side view of an alternate embodiment of the invention having LEDs 16, 19 around the top and sides of the ring assembly. The top section of the ring having features to direct the light source towards an operating area. These features include a protruded outer ring 17 and reflector 18 around the top grouping of LEDs 26 to better direct the light towards the operating area. The protrusion 17 will preferably direct light forward towards the direction of the front of the user's finger. The reflector 18 covering the side, bottom and top sections of the top grouping of LEDs 16 will be housed in the inner cavity of the ring. Side LED groupings 19 will not have reflective material. Finally, the battery 9 and control mechanism 10 are housed at the bottom of the ring. It is also preferred that the battery 9 is rechargeable and to be used with a docking station (not depicted) so that the ring need not be disassembled for recharge. The rechargeable battery 9 and docking station preferably uses inductive charging.

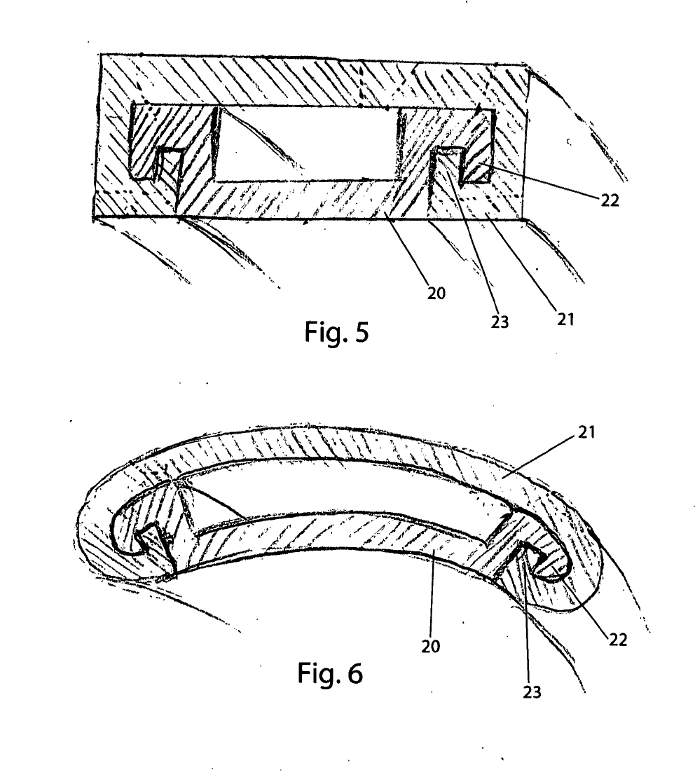

Referring to FIGS. 5 and 6, alternatively, the ring assembly may comprise two rings, an inner ring 20 and an outer ring 21. The outer ring 21 acts as a cover a shield for the inner ring. The inner and outer rings 20, 21 having means for attachment to one another. In this embodiment, the means for attachment are complimentary lipped protrusions 22, 23. It is preferable that the lipped protrusions not be present in the top section of the ring as to allow for more light to pass. It is preferred that the outer ring 21 be made of flexible material to facilitate deformation in order to mate with the lipped protrusion 22 of the inner ring 20. The outer ring 21 may have different sections with and without UV filters. Thus, the outer ring 21 may be rotated by the user with respect to the inner ring 20 allowing for the user to adjust between a filter and non-filter mode of use. Furthermore, in this alternative embodiment with the uniform shape and rotatable UV filter outer ring 21, the outer ring 21 may further be grooved or textured to allow the user to more easily rotate the outer ring 21. It is anticipated that an adhesive may be used as a means for attachment of the inner ring 20 and outer ring 21.

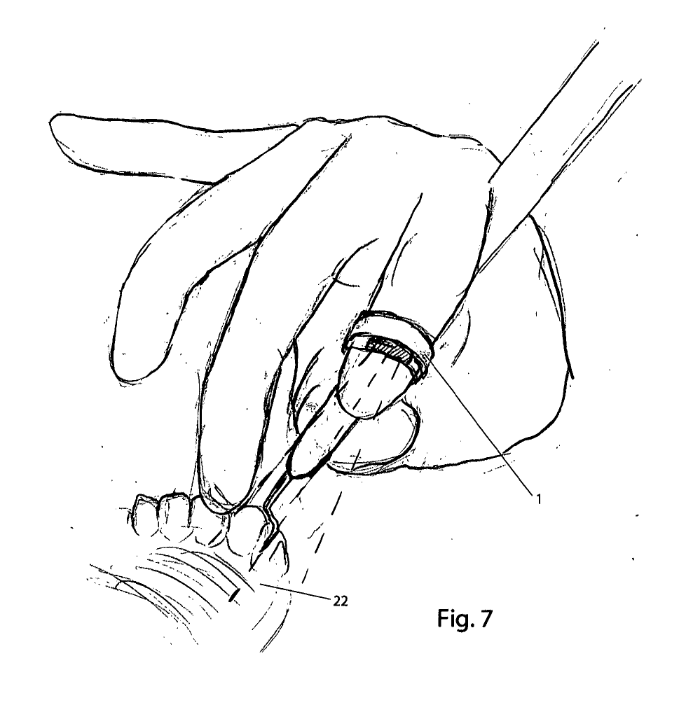

FIG. 7 depicts the ring 1 being used in dental surgery. The ring 1 effectively and efficiently directs illumination to the working area 22 which is directly in front of the user's finger tips.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention is in its broader aspects is therefore not limited to the specific details, representative apparatus and method and illustrative examples shown and described. Accordingly, departures may be made from such details without departing from the general inventive concept.

What is claimed is:

1. An illumination device comprising:
a ring having a front face facing the finger tip of the ring bearing hand when worn and the hand is in a flat resting position with palm faced down, a back face facing the wrist, a top section corresponding to the knuckle, a bottom section corresponding to the palm, an inner side section corresponding to the thumb, and an outer side section opposite to the inner side;
at least one LED;
a battery;
power control switch;
and at least one electromechanical control means to adjust the intensity of the illumination.

2. An illumination device comprising:
a ring having a front face facing the finger tip of the ring bearing hand when worn and the hand is in a flat resting position with palm faced down, a back face facing the wrist, a top section corresponding to the knuckle, a bottom section corresponding to the palm, an inner side section corresponding to the thumb, and an outer side section opposite to the inner side;
illumination means for providing illumination from the front face of the ring;
means for controlling the illumination;
and a battery.

3. The device of claim 2, wherein the illumination means is at least two LEDs.

4. The device of claim 3, wherein the at least two LEDs emit light of different wave lengths.

5. The device of claim 3, wherein the one of the at least two LEDs is provided with UV filter.

6. The device of claim 2, further having retention means for retaining the ring onto the user's fingers and for allowing the ring to be worn on fingers of different diameters.

7. The device of claim 6, wherein the retention means are a plurality of deformable protrusions extending from an inner cylindrical circumference towards the center of the ring.

8. The device of claim 2, wherein the means for controlling the illumination is located at the bottom section of the ring corresponding to the palm.

9. The device of claim 2, wherein the means for controlling of the illumination is located at the inner side section of the ring.

10. The device of claim 2, wherein the ring is made of an inner ring housing the components and an outer ring acting as a protective cover for the components.

11. The device of claim 2, further having means for reflecting the illumination towards the front face.

12. The device of claim 2, wherein the means for controlling the illumination allows the user to adjust the intensity of the illumination.

13. The device of claim 2, wherein the illumination means is housed in the top section of the ring.

14. The device of claim 13, wherein the illumination means is also housed in the side sections of the ring.

15. The device of claim 2, wherein the illumination means is an OLED.

16. The device of claim 2, further having means for filtering UV light.

17. The device of claim 2, further having means for intensifying UV light.

18. The device of claim 2, wherein the illumination means further provides illumination from the top section's top surface.

19. The device of claim 2, wherein the ring is made from medical grade silicone that is elastic allowing the ring to deform to fit around the finger.
